(19) United States
(12) Patent Application Publication
(10) Pub. No.: US 2002/0090496 A1
(43) Pub. Date: Jul. 11, 2002

(54) Adhesive tapes and adhesive note pads featuring non-adhesive sections

(75) Inventors: Sang-Hoon Kim, Hackensack, NJ (US); Kyoung-Haw Park, Shiheung-shi (KR); Jung-Hwan Park, Shiheung-shi (KR)

Correspondence Address: OSTROLENK FABER GERB & SOFFEN, 1180 AVENUE OF THE AMERICAS, NEW YORK, NY, 100368403

(73) Assignee: Sang-Hoon Kim

(21) Appl. No.: 10/001,673

(22) Filed: Oct. 31, 2001

(30) Foreign Application Priority Data
Nov. 2, 2000 (KR) 2000-0030720
Nov. 1, 2000 (KR) 2000-0064763

(51) Int. Cl. B32B 3/00

(52) U.S. Cl. 428/201; 428/343

(57) ABSTRACT

A single-sided adhesive tape comprises a film; and a pattern on the film comprising adhesive and non-adhesive sections, wherein the pattern is repeated more than two times across said film with a predetermined spacing therebetween. A double-sided adhesive tape comprises a film having two opposing sides; and on each side, a pattern comprising adhesive and non-adhesive sections, wherein the pattern is repeated more than two times with a predetermined spacing therebetween. Preferably the adhesive sections of the adhesive tape are narrower than the non-adhesive sections. The adhesive sections and non-adhesive sections may be formed in a stripe, checkerboard, wave or dot pattern. The tape can be used as an adhesive note pad or a tape flag, for example. Another aspect of the invention relates to a dispenser containing the tape, the dispenser having an outlet with an arrangement on an inside cover and at a tape outlet of the dispenser which permits the adhesive tape to be moved horizontally and vertically for being discharged without substantially adhering to the dispenser.

### BACKGROUND OF THE INVENTION

1. Field of the Invention

The invention pertains to adhesive products, and more particularly to tapes and adhesive note pads, for example, that feature adhesive and non-adhesive sections in various formats.

2. Related Art

Many types of adhesive tapes are known, including the well-known Scotch-brand tapes, having a wide variety of applications. Other examples are kraft tapes, packing tapes and industrial tapes. These tapes are differentiated according to the sides onto which the adhesive is coated, namely, single-sided and double-sided, and their degrees of transparency, namely, clear, translucent and opaque.

In addition, there are many other tape-like products, such as adhesive note pads, labeling tapes (such as so-called tape flags) and tapes similar to the so-called “Post-it notes”, which are in wide use for posting messages and as reminder notes.

At the present time, all of the adhesive tapes described above, whether single-sided tape or double-sided tape, have adhesive that covers the entire surface of the adhesive side or sides, without having any non-adhesive sections on that adhesive side. Therefore, due to the current practice of completely covering the adhesive side with adhesive, excessive amounts of adhesive are used. In the case of double-sided tapes, an additional lining (or a release layer) is added to protect the adhesive, resulting in higher material costs and waste.

At the present time, adhesive tapes, adhesive note pads, tape flags and Post-it Notes are used in homes, offices, schools and kindergartens, industrial sites and hospitals. Regardless of the strength of the adhesive, the adhesive covers the entire width of both double-sided tapes and single-sided tapes. Thus, tapes of this type use excessive amounts of adhesive and double-sided tapes require additional lining to protect the adhesive.

The invention solves the problems cited above concerning excessive adhesive and excessive waste products, and protects the environment by providing a design featuring adhesive and non-adhesive patterns that repeat more than two times, i.e., wherein at least three patterns are disposed on the tape, counting them in a width direction across the tape.

There are largely two kinds of adhesive tapes: single-sided and double-sided. The single-sided tape is coated with adhesive on one side of the film and the double-sided tape is coated with adhesive on both sides of the film.

The materials of the tapes consist for example of paper (for the purpose of interior decoration and painting), cloth (bandages and blue-color tape), synthetic plastics (packing tapes and electrical tapes), gold foil and silver foil (for electronic, semi-conductor and piping purposes) and urethane.

Among these products, the tapes that are most widely used for general purposes are those similar to the so-called “Scotch-brand cellophane tape” and “Scotch Magic Tape,” which are made as a rolled film and may be a single-sided or double-sided tape.

There are also tapes which are used as stationery, such as rectangle-shaped posting tapes featuring single-sided adhesive, labeling tapes such as tape flags, and adhesive note pads (“Post-it Notes”), which are used for posting messages and as reminder notes.

These products are made with different materials and have different shapes according to their purpose, but regardless of whether the adhesive-containing sections are wide or narrow, the adhesive covers the entire surface in the width direction of the tape. In the case of double-sided tapes, additional linings to protect the adhesive are required regardless of the materials used, be they film or urethane.

Therefore, current products routinely have to use excessive amounts of adhesive, which is a major reason for increases in product cost, waste of materials and, in particular, contamination of the environment by generating increased waste due to the disposal of discarded linings. Furthermore, current double-coated tapes without linings must use special low-strength glues so that the glue layers can be successively adhered to and removed from each other.

### SUMMARY OF THE INVENTION

The tapes and tape-like products according to the invention solve the problems cited above while simultaneously providing cost-effective and convenient products. These new products, such as adhesive tapes, adhesive note pads and labeling tapes such as tape flags, are designed with a stripe, dot or wave pattern in adhesive and non-adhesive sequences, with the pattern repeating more than two times across the tape, that is, in the side-to-side direction defined between the longitudinal edges of the tape. These designs thus result in an advantageous reduction of costs. In addition, they are environmentally friendly; for example, in the case of the double-sided tapes, additional linings are not necessary, which further reduces waste materials. Furthermore, stronger glues can be used, even in double-coated tapes without linings.

Other features and advantages of the invention will be appreciated from the following detailed description of embodiments thereof, with reference to the drawings, in which like references denote like elements and parts.

### BRIEF DESCRIPTION OF THE DRAWINGS

FIG. 1(a): Embodiment 1. Perspective view of double-sided tape with adhesive and non-adhesive pattern on both sides;

FIG. 1(b): Embodiment 2. Perspective view of single-sided tape with adhesive and non-adhesive pattern on one side;

FIG. 2(a): Side view of FIG. 1(a);

FIG. 2(b): Side view of FIG. 1(b);

FIG. 3(a): Sectional detailed view of FIG. 1(a) and FIG. 2(a): double-sided tape with adhesive and non-adhesive pattern on both sides;

FIG. 3(b): Sectional detailed view of FIG. 1(b) and FIG. 2(b): adhesive and non-adhesive patterns on single-sided tape;

FIG. 4: Embodiment 3. Perspective view of adhesive note pad with adhesive and non-adhesive pattern;

FIG. 5(a): Cross-sectional detailed view of single adhesive note;

FIG. 5(b): Enlarged view of FIG. 5(a);

FIG. 5(c): Cross-sectional view of enlarged detail of FIG. 4;

FIG. 6(a): Embodiment 4. Perspective view of tape flag with adhesive and non-adhesive in a stripe pattern;

FIG. 6(b): Embodiment 5. Perspective view of tape flag with adhesive and non-adhesive in a wave pattern;

FIG. 7: Cross-sectional view of single-sided tape flag with adhesive and non-adhesive pattern on one side;

FIG. 8: Cross-sectional view of double-sided tape flag with adhesive and non-adhesive pattern on both sides;

FIG. 9: Detailed cross-sectional view of FIGS. 6(a) and 6(b);

FIG. 10: View from below of top cover of tape flag dispenser of FIG. 6, and hand-held tape dispenser of FIG. 13;

FIG. 11: Cross-sectional detailed view taken along line A-A, as designated in FIG. 10;

FIG. 12: Cross-sectional detailed view taken along line B-B, as designated in FIG. 10;

FIG. 13: Perspective view of hand-held tape dispenser;

FIGS. 14(a), 14(b) and 14(c): Each figure shows a plan view and a sectional view of a respective single-sided tape according to a modified embodiment of the invention; and

FIGS. 15(a), 15(b) and 15(c): Each figure shows a top plan view, a sectional view, and a bottom plan view of a respective double-sided tape according to a modified embodiment of the invention.

### DETAILED DESCRIPTION OF EMBODIMENTS OF THE INVENTION

In order to achieve the targeted solution, the adhesives used for the various roll tapes, adhesive note pads and labeling tapes are arranged to partially coat tapes or note pads by employing straight lines or wave patterns, and other patterns, and then apply those patterns more than two times on such tapes or note pads.

Alternatively, dotted, wavy or checkered patterns, for example, can be created in the adhesive sections of the tapes. This will not only maintain the strength of the tapes, but also greatly decrease the consumption of adhesive. Moreover, this will enable the manufacture of double-sided tapes without using an additional lining.

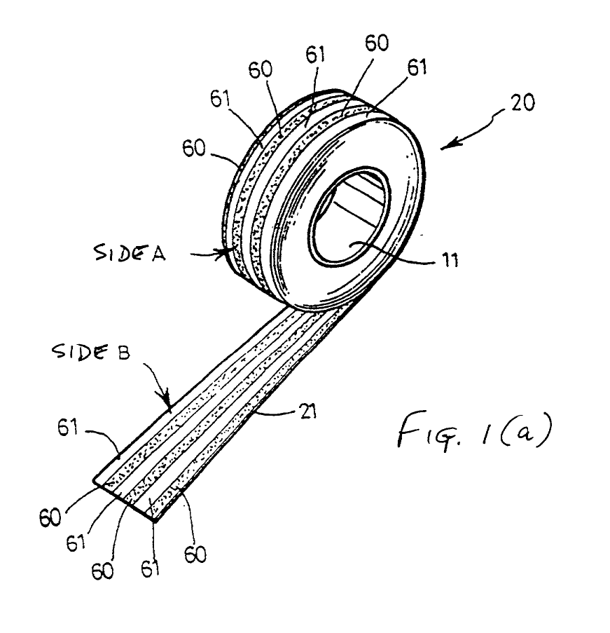

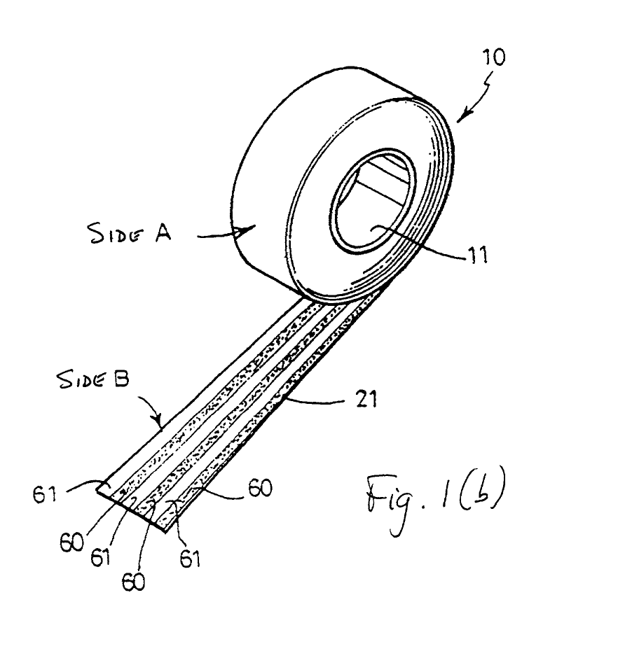

Embodiment 1 is illustrated in FIG. 1(a) and FIG. 1(b). Embodiment 1 in FIG. 1(a) serves to explain double-sided tape (20). Embodiment 2 in FIG. 1(b) explains single-sided tape (10).

The location where adhesive sections (60) are coated onto film (21) determines if the tape is intended to be a single-sided tape (10) or a double-sided tape (20). If the adhesive is coated on one side (side B in the figures), the tape becomes a single-sided tape, and if the adhesive is coated on both sides of the tape (sides A and B in the figures), it becomes a double-sided tape.

When adhesive sections (60) and non-adhesive sections (61) are designed in the form of stripes on one or both sides of the film (21), the adhesive sections (60) are designed narrower than the non-adhesive sections (61), and the pattern is repeated more than two times across the tape. In Embodiments 1 and 2, for example, the pattern repeats three times.

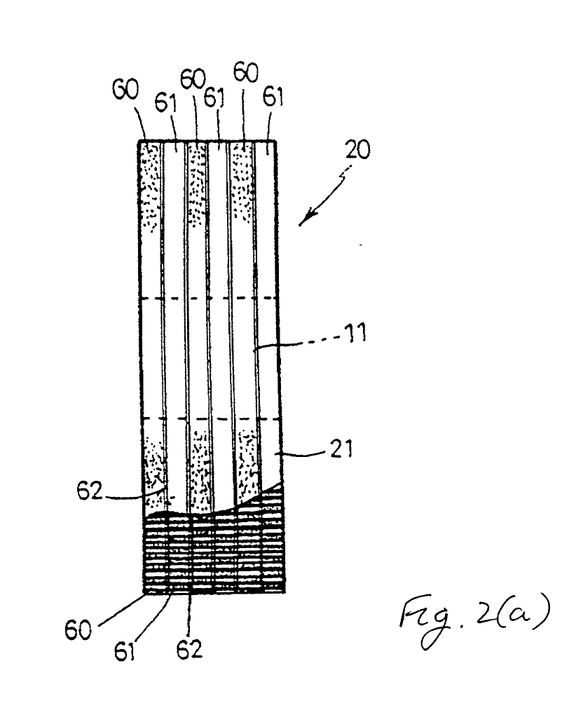

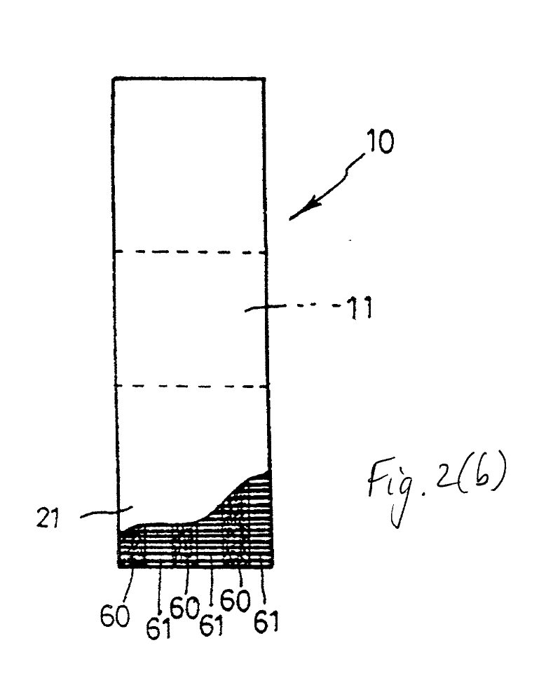

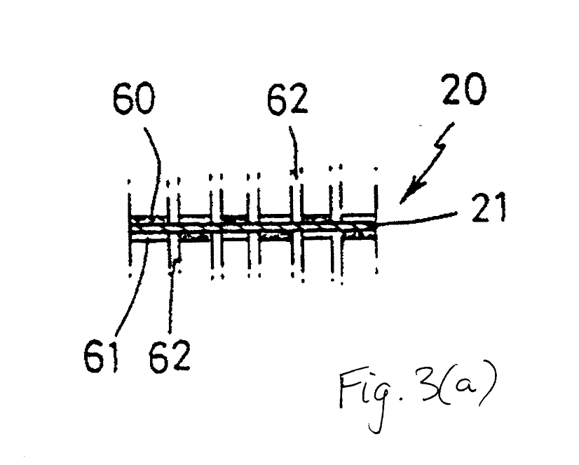

The reason for the adhesive section (60) to be designed narrower than the non-adhesive section (61), as shown in FIG. 2(a) and FIG. 3(a), is to provide a space (62) between the adhesive sections (60), and for the respective adhesive sections (60) on sides A and B to stick to the corresponding opposed non-adhesive sections (61) without contacting each other when the double-sided tapes (20) are wound onto and off of a bobbin (11).

The space (62) provides sufficient space between the A and B adhesive sections (60) on the double-sided tape (20), even if the A and B adhesive sections (60) expand out to the side when the tape is wound onto the bobbin (11). This space will prevent the possible problem of the adhesive sections (60) of the two sides A and B sticking together.

When the double-sided tape (20) is wound onto bobbin (11) as a roll, the “A” side is outside and the “B” side is inside. The “A” side of the adhesive section (60) will be rolled in contact with the “B” side of the non-adhesive section (61), as shown in FIG. 3(a), and the “B” side of the adhesive section (60) will be rolled in contact with the “A” side of the non-adhesive section (61).

Therefore, in the case of a double-sided tape (20) no adhesive is needed for the area of the non-adhesive section (61), which results in adhesive savings that correspond to the size of this area. This method also enables rolling the tape without requiring an additional lining for the non-adhesive section (61) of the “A” and “B” sides.

Furthermore, in the case of a double-sided tape (20), when employing the same method the adhesive sections will be decreased in even more areas with respect to the non-adhesive sections (61). If it becomes necessary to remove a double-sided tape (20) from any given object, it is easier to remove the tape without a tool such as a knife, due to the fact that the non-adhesive (61) sections of the tape have created empty spaces between the tape and the object. Moreover, the spot where the tape has been removed will be cleaner, as compared to a spot from which a conventional tape with adhesive covering its entire surface is removed.

FIG. 1(b) shows Embodiment 2. Embodiment 2 features adhesive section (60) and non-adhesive section (61) using straight-line patterns on film (21).

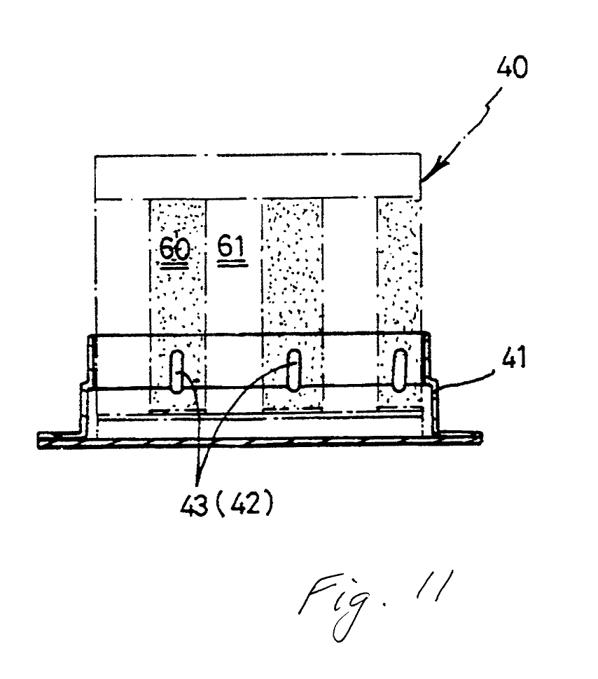

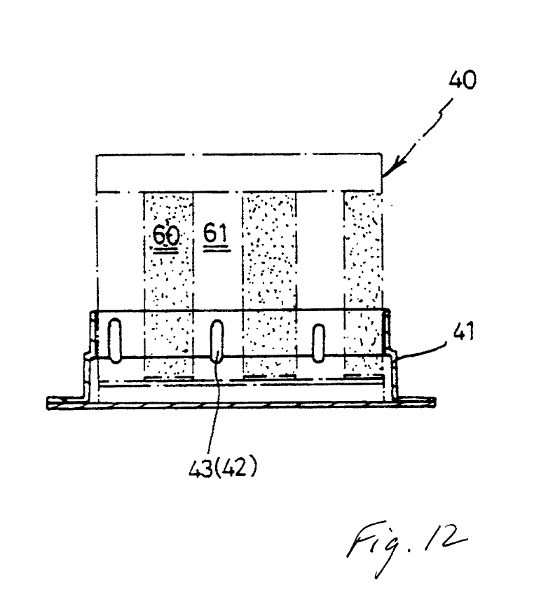

FIGS. 14(a), 14(b) and 14(c) each show a plan view and a sectional view of a single-sided tape according to a respective modified embodiment of the invention. In these embodiments, the patterns are checkered, dotted and wavy, respectively.

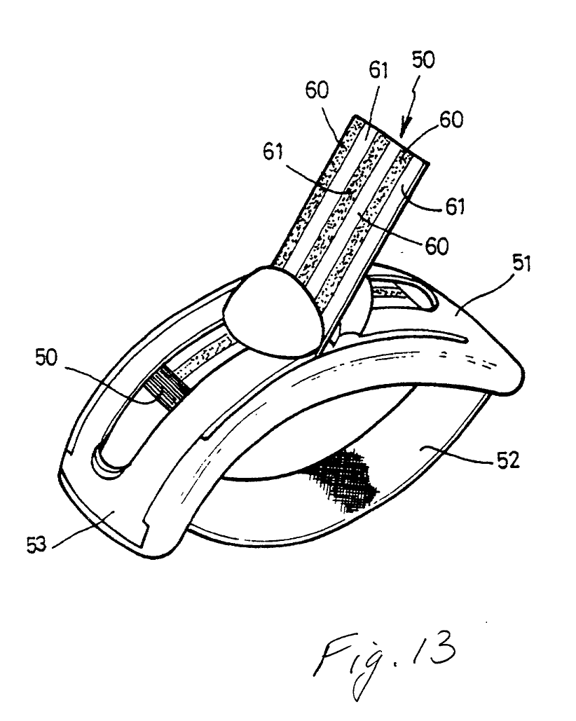

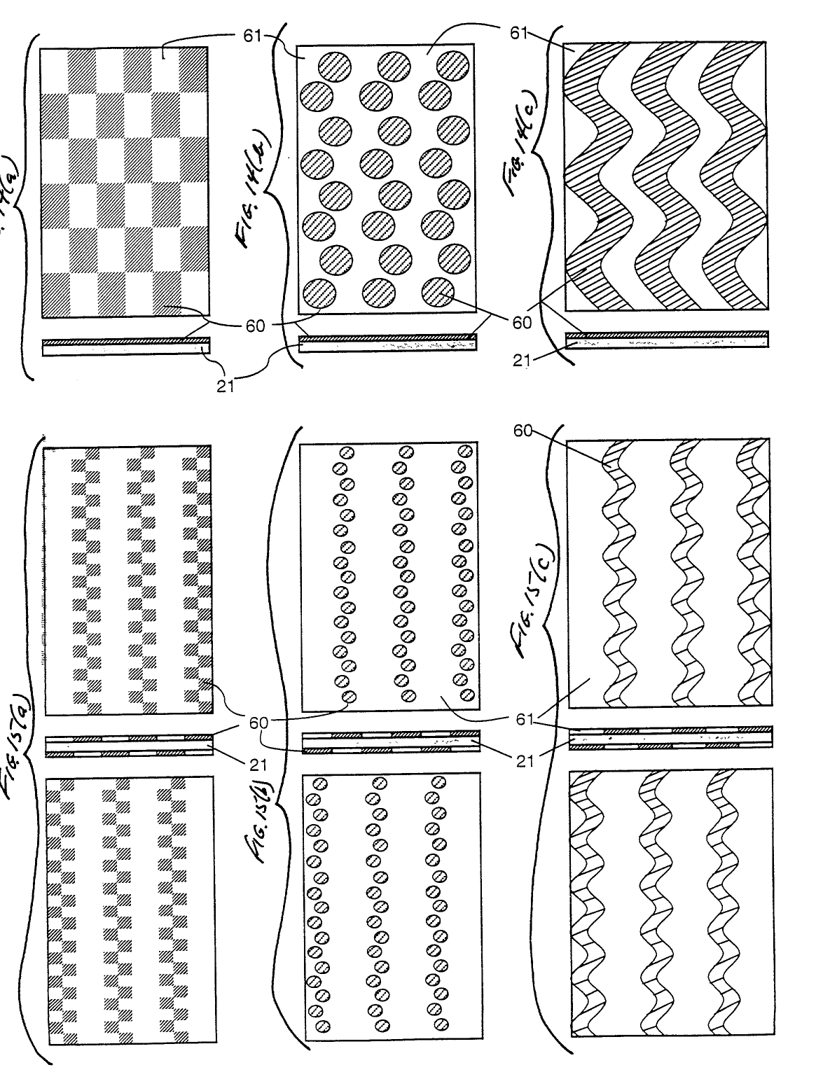

FIGS. 15(a), 15(b) and 15(c) each show a top plan view, a sectional view, and a bottom plan view of a double-sided tape according to a respective modified embodiment of the invention. In these embodiments, the patterns are checkered, dotted and wavy, respectively.

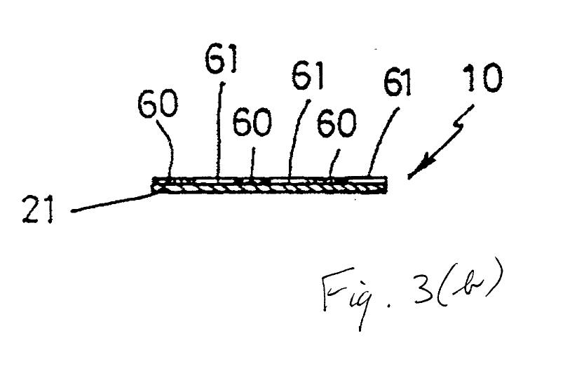

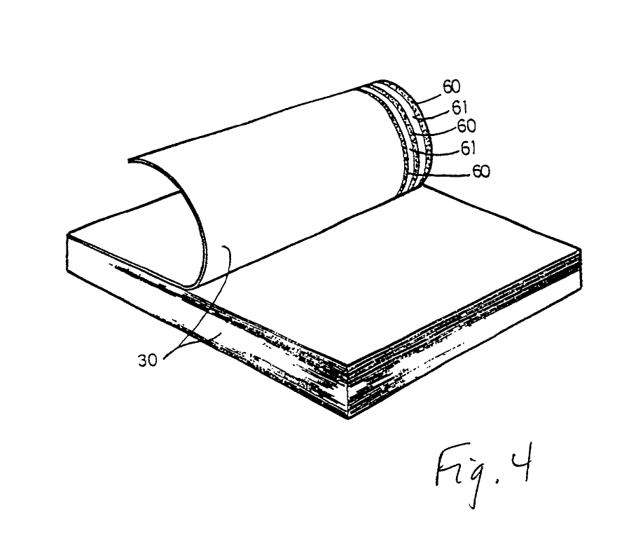

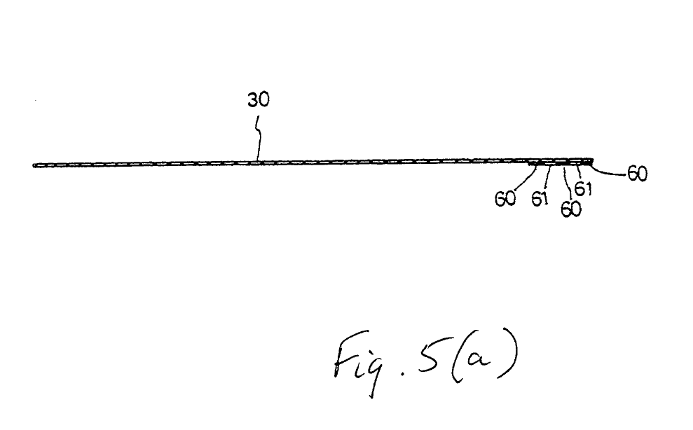

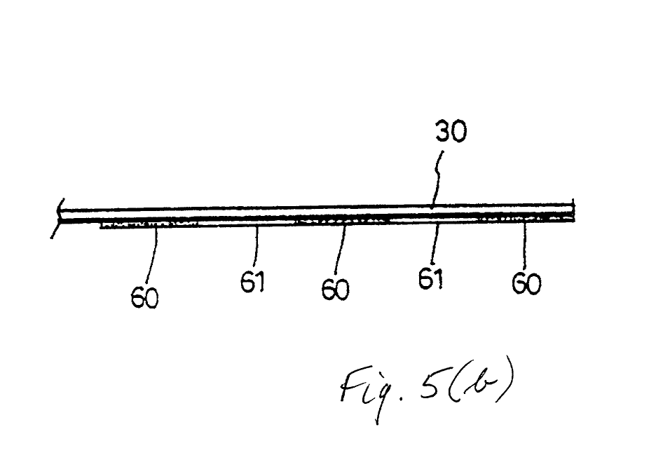

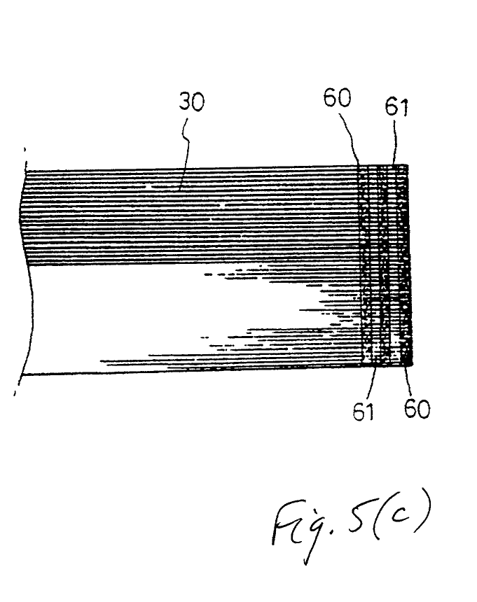

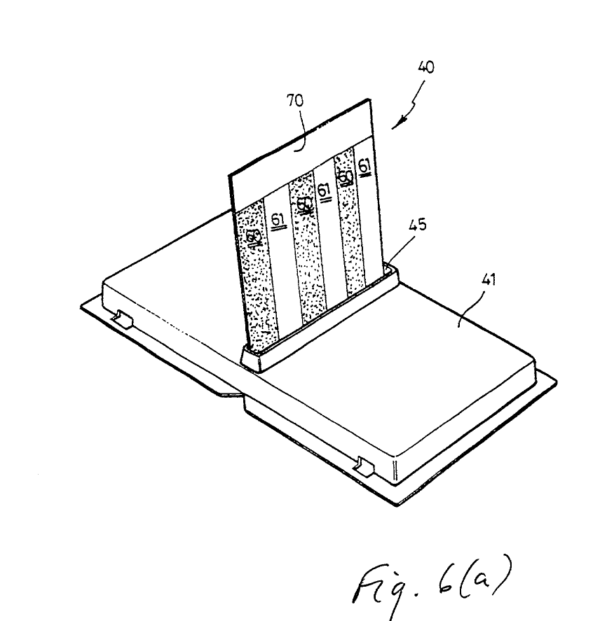

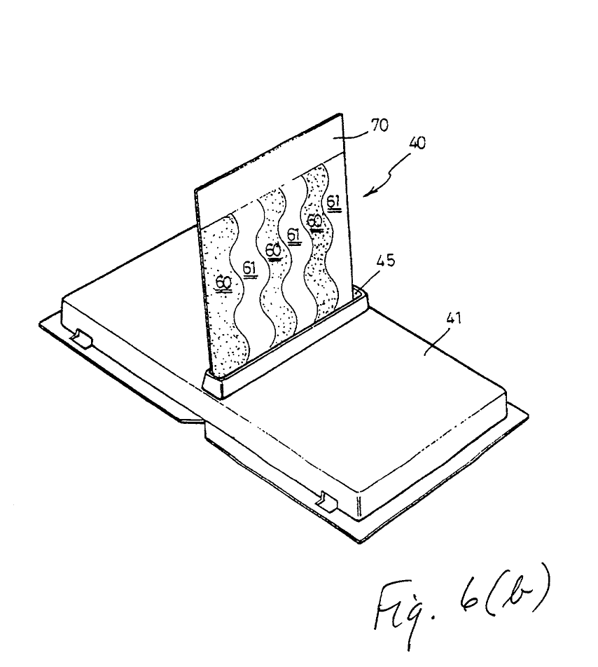

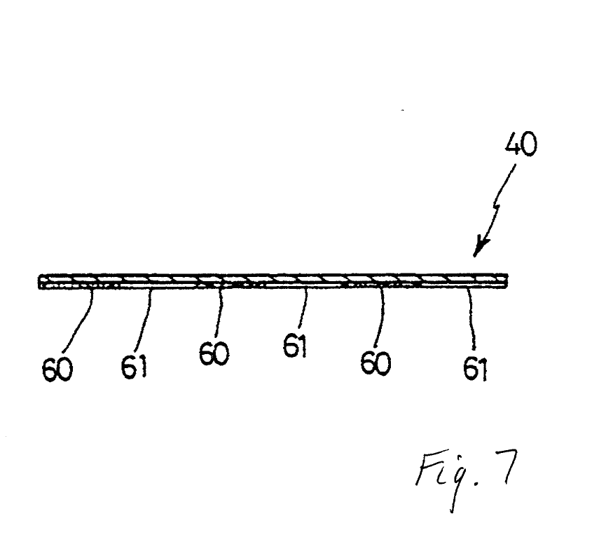

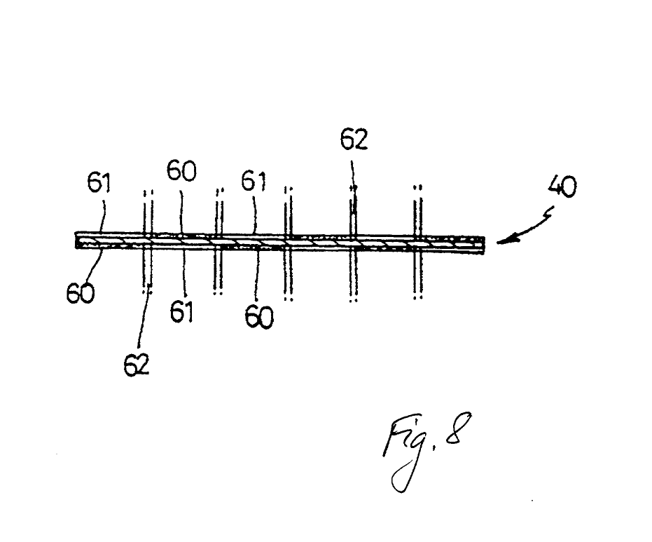

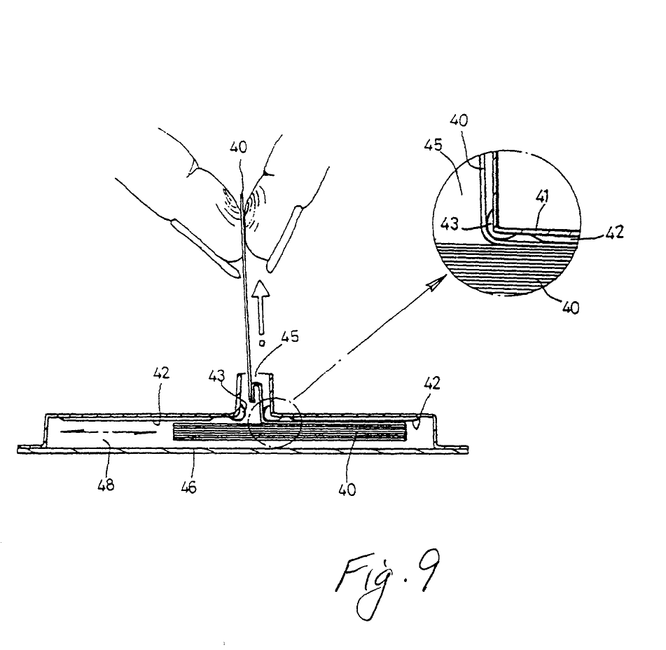

FIG. 4 relates to Embodiment 3. Embodiment 3 is an adhesive note pad (30). In Embodiment 3, the adhesive (60) and non-adhesive (61) sections form a stripe or wave pattern or, if desired, a dot pattern, which repeats more than two times where needed, namely, in the upper section, in a corner or on the front and reverse side of adhesive note pad (30), for example.

FIG. 6(a) pertains to Embodiment 4. This embodiment is an example of a tape flag (40). With regard to tape flag (40), to provide for adhesive (60) and non-adhesive (61) sections, the adhesive (60) and non-adhesive (61) sections are created by employing a stripe or wave pattern that is repeated more than two times on either the “A” or “B” side of tape flag (40), with the exception of a writing section or colored section (70) on the labeling tape. The section (70) is not drawn to scale and may constitute either more or less than shown of the entire area of the tape flag (40).

Tape flag (40), unlike both the roll-shaped single-sided tape (10) and the double-sided tape (20) that feature adhesive (60) and non-adhesive (61) sections that preferably have a stripe pattern, to avoid having opposed adhesive sections contacting each other, may in addition use a wave pattern, a dot pattern or another pattern as shown in FIG. 6(b). This arrangement pertains Embodiment 5.

The tape dispenser (41) is provided on its inside with an arrangement whereby the tape is movable both horizontally (42) and vertically (43) for being discharged, as shown in FIGS. 9 through FIG. 12. This arrangement is formed on the interior cover of tape dispenser (41) and outlet (45) in order to match the non-adhesive sections (61) of tape flag (40). Providing a clearance (48) enables the tape flag (40) to move straight (42) in the lateral direction and easily slide through clearance (48) as well as be separated off easily when tape flag (40) is pulled from tape dispenser (41).

A pack of tape flags (40) made of pre-cut pieces is placed inside tape dispenser (41) on top of back cover (46), as shown in FIG. 9. The pack of tape flags (40) can move both in the left and right direction within clearance (48) and the pre-cut pieces are dispensed one at a time whenever they are pulled from outside.

The pack of tape flags (40), as shown in FIG. 9, can move alternately in the left and right directions, usually in the direction opposite to the user's pulling direction, and the non-adhesive section (61) of the top tape flag (40) is guided horizontally (42) thus performing a sliding action.

Immediately after one tape flag (40) has popped outside, the next tape flag (40) proceeds toward outlet (45) as the user continues to pull the first tape flag, at which time the tape flag (40) that is moving through outlet (45) passes the discharge arrangement, as shown in FIGS. 9 and 12.

Each tape flag (40) bends at a right angle, as shown in FIG. 9, while passing through outlet (45), and the non-adhesive section (61) is guided by the horizontal (42) and vertical (43) discharge arrangement.

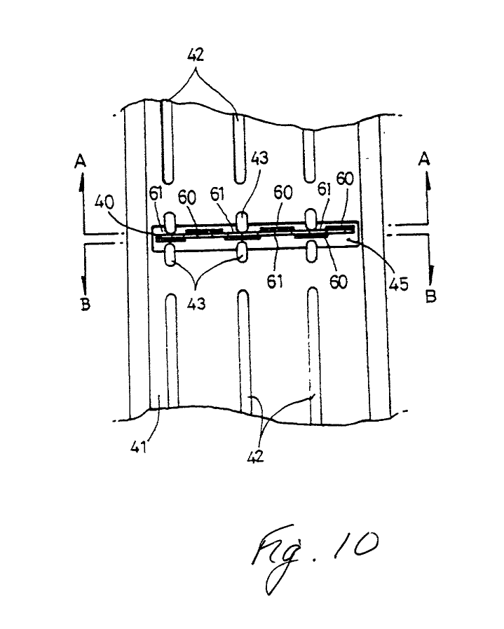

The above-mentioned structure and operation also apply to tape (50) for a dispenser, which may be a hand-held dispenser, as shown in FIG. 13.

Tape (50) corresponds to Embodiment 6. The adhesive (60) and non-adhesive (61) sections can be applied on either one or both sides of the film of tape (50), as shown in the figure.

Tape (50) is provided as a package of sheets, like the tape flags (40), with the adhesive (60) and the non-adhesive (61) sections being applied on either one or both sides of the film of tape (50).

Tape (50) for the hand-held dispenser is manufactured according to the above method and is supplied as a package of sheets that can easily be refilled and inserted into a hand-held dispenser (51). The interior structure of hand-held dispenser (51) as well as the method of pulling the tape out correspond to those of tape flags (40) and tape flag dispenser (41) as explained previously, namely, the interior cover, the refill cover (53) and the outlet (45) are equipped with an arrangement permitting the tape to be moved both horizontally (42) and vertically (43) when discharged, so that tape (50) can be moved freely within a clearance (48). This method has been explained previously and thus will not be repeated here.

Thus, according to the above-described aspects of the invention, the stripe pattern on the adhesive (60) and non-adhesive (61) sections is repeated more than two times on both the single-sided tape (10) and double-sided tape (20) that are provided in the form of rolls, on the adhesive note pad (30), the tape flag (40), and the tape (50) for a possibly hand-held dispenser. By repeating the stripe pattern of the adhesive (60) and the non-adhesive (61) sections more than two times, or by systematically creating a wave or dot pattern with the adhesive, for example, the cost of the adhesive will be reduced and the non-adhesive sections substitute for a lining.

By these and other features, firstly, the consumption of adhesive will be reduced, corresponding to the area where the single-sided tape (10) and double-sided tape (20) in the form of a film are wound onto bobbin (11) with the adhesive (60) and non-adhesive (61) sections.

Secondly, the use of lining will be eliminated and the cost of materials will be drastically reduced due to the fact that non-adhesive section (61) substitutes for a protective lining for adhesive section (60).

Thirdly, the stripe pattern of adhesive section (60) and non-adhesive section (61) will allow for sheets or tapes to be cut more easily with the result that stronger adhesive (60) can be used. This invention is particularly advantageous since it will be possible to use an adhesive with a strength that is several times that of the adhesive currently employed with double-sided tapes in which the adhesive covers the entire film surface. Thus, the strong glues currently used in single-sided tapes, or even stronger glues, can be used in double-coated tapes according to the invention, instead of the weaker glues currently used in conventional double-coated tapes, with less glue consumption and without any increase in cost.

Although embodiments of the invention have been described, the invention is not limited to those embodiments, but extends to all modifications, variations and alternate applications thereof that would occur to those having the ordinary level of skill in the pertinent art.

What is claimed is:

1. A single-sided adhesive tape comprising:
a film; and
a pattern on said film comprising adhesive and non-adhesive sections, wherein the pattern is repeated more than two times across said film with a predetermined spacing therebetween.

2. A double-sided adhesive tape comprising:
a film having two opposing sides; and
on each side, a pattern comprising adhesive and non-adhesive sections, wherein the pattern is repeated more than two times with a predetermined spacing therebetween.

3. A tape according to claim 1 or claim 2, wherein the adhesive sections of the adhesive tape are narrower than the non-adhesive sections.

4. A tape according to claim 1 or claim 2, wherein the adhesive sections and non-adhesive sections are formed in a stripe, checkerboard, wave or dot pattern.

5. A tape according to claim 4, wherein said film comprises a material selected from the group consisting of paper, cloth, synthetic plastics, gold foil, silver foil, and clear, opaque and transparent sheets.

6. A tape according to claim 1 or claim 2, wherein said film comprises a note pad.

7. A tape according to claim 1 or claim 2, further comprising a dispenser containing said tape, said dispenser having an arrangement on an inside cover and at a tape outlet of said dispenser which permits the adhesive tape to be moved within and discharged from said dispenser without substantially adhering to said dispenser.
